(19) United States
(12) Patent Application Publication
(10) Pub. No.: US 2016/0012144 A1
(43) Pub. Date: Jan. 14, 2016

(54) JAVASCRIPT-BASED, CLIENT-SIDE TEMPLATE DRIVER SYSTEM

(71) Applicant: MyMojo Corporation, Dallas, TX (US)

(72) Inventor: Michael Benjamin, Cedar Park, TX (US)

(73) Assignee: MyMojo Corporation, Dallas, TX (US)

(21) Appl. No.: 14/328,630

(22) Filed: Jul. 10, 2014

(51) Int. Cl. G06F 17/30

(52) U.S. Cl. CPC G06F 17/30896; G06F 17/30905

(57) ABSTRACT

A method in a client web browser for preventing collisions and eliminating polling for matching Document Object Model (DOM) elements while operating a website. The browser receives from a server, information for creating a DOM from a plurality of DOM modules. A module includes a template and a Driver. A unique class attribute for the Driver is created from an identifier tag, enabling the Driver to operate independent of other modules. A variable set to reference a DOM element in the template is utilized to sandbox all actions by the Driver into the referenced DOM element in the template, thereby preventing collisions and eliminating polling for matching DOM elements. The Driver retrieves data for the module, replaces tags in the template with corresponding data, attaches event listeners to defined DOM elements in the template, and manipulates DOM elements as needed to enable user interaction with the DOM module.

### TECHNICAL FIELD

The present disclosure relates to a method of assembling the contents of a website in a modular fashion while preventing collisions and eliminating polling for matching Document Object Model (DOM) elements while operating the website.

### BACKGROUND

A website document, which is designed to be viewed in a web browser, comprises HyperText Markup Language (HTML) markup and various assets, which are parsed by the web browser and laid out to form a visible web page. The assets include images, Cascading Style Sheet (CSS) documents, JavaScript documents, as well as any embedded media. The common practice, and industry standard, is to load the HTML of the page, and then parse other assets to alter the layout of that HTML, place images as needed, and set “listeners” (triggers) on various Document Object Model (DOM) elements in order to react to user input. The DOM is an Application Programming Interface (API) for valid HTML and well-formed XML documents. It defines the logical structure of documents and the way a document or data is accessed and manipulated. This procedure typically causes the website to be parsed as a monolithic document with JavaScript and CSS resources loaded either in the header of the DOM and/or near the bottom, so that scripts can attach listeners to, or otherwise alter, referenced DOM elements.

FIG. 1 illustrates a typical coding structure for a conventional simple website. The typical method of programming a website includes HTML mark up to set up the structure of the site. On line 7 of the code in FIG. 1, a CSS document is referenced, which causes the web browser to request the CSS document from the server. Only after the browser loads the CSS document does the browser continue to parse the rest of the HTML mark up. On line 13 of the code in FIG. 1, a JavaScript document is referenced. This reference causes the web browser to request the JavaScript document from the web server, and the code contained in the JavaScript document is compiled and run by a JavaScript engine in the browser. At that point, if the JavaScript code calls for a listener to be attached to a particular DOM element in the HTML mark up, a reference for the particular DOM element is made by the element's ID attribute, or by the element's class attribute. This requires a poll of every DOM element in the page to take place in order to find any and all elements that match the reference set by the JavaScript code. If the page is short, this polling is minimal. However, if the page is very long, and several elements are referenced by the JavaScript code, this polling becomes very expensive in terms of performance. Additionally, if care is not taken to ensure that elements have unique ID's and classes, a greedy reference by the JavaScript will cause the wrong elements to be affected, and the website functionality will become unstable and unreliable.

In the case of a conventional “static” website, when the user clicks on a link, for example a link from a home page to a sub-page of the website, the browser destroys the DOM instance for the home page and unloads it from memory. The browser then sends an HTTP request to the server requesting information from the server for the sub-page. The browser then creates a new DOM instance for the sub-page. Thereafter, this process of downloading resources, creating a new DOM instance, and then destroying the DOM instance and starting over is repeated for each new page requested by the user.

FIG. 2 is a message flow diagram illustrating the flow of messages between a user 10, a client browser 11, and a website server 12 in a method of operating a conventional static website. At step 13, the user types in a web address directing the browser to go to the website, somesite.com/home. At step 14, the browser requests information from the server for the home page of somesite.com by sending an HTTP request to the server. At step 15, the server processes the request and returns to the browser, a string containing resources such as full HTML, CSS documents, JavaScript code, and all content data associated with the home page. At step 16, the browser interprets the HTML code and creates a new DOM instance. In optional steps 17 and 18, the browser may request and receive from the server, cacheable resources that have not yet been downloaded.

At step 19, the browser interprets and executes the JavaScript code, and displays the somesite.com home page to the user. At step 20, the user browses the home page, and at step 21, attempts to view content that was not included in the original content data received from the server. For example, the user may click on a link to a sub-page of the somesite.com website. In response, the browser destroys the DOM instance for the home page and unloads it from memory at step 22. At step 23, the browser then sends an HTTP request to the server requesting information from the server for the sub-page of somesite.com. The process then repeats, with the browser creating a new DOM instance for the sub-page. Thereafter, this process of downloading resources, creating a new DOM instance, and then destroying the DOM instance and starting over is repeated for each new page requested by the user.

In order to break the monolithic nature of a website and cause the content to be delivered in a modular fashion, a templating system is often used. In such a system, reusable HTML markup code is used as a template, and a data source is used to populate various portions of the template, before being rendered as needed within the webpage. There are basically two types of templating systems—those that run on the server side, and those that run on the client side. In both instances, a data source is used to populate various fields within an HTML template, and the resulting HTML code is returned to the web browser for display.

FIG. 3A illustrates a typical coding structure for producing a simple server-side template. Server-side templates take data from a data source, populate the template, and then piece together the rendered results to create a single web page, before sending it to the browser for display. Server-side templates employ a templating engine in the server-side code to populate templates that are coded in HTML and either a proprietary templating language or the corresponding server-side code.

FIG. 3B illustrates a typical coding structure for replacing the tags in the server-side template of FIG. 3A with data. Server-side code such as PHP: Hypertext Preprocessor (PHP) takes data from a data source and makes a call to the templating engine to replace the tags in the template with the data. Thus, in the above example, a typical templating engine is invoked, provided with variables from a data source, and then rendered to return the HTML to the client browser.

Server-side templating engines separate presentation development from data modeling and business logic development, and provide a code base that is easier to maintain and change as needed. Server-side templating engines also allow for HTML template code to be reused, which reduces the amount of code that has to be written, which in turn reduces the chances for bugs or breaking functionality when changes are made. However, server-side templating engines return full HTML documents to the client, and much of the HTML being transferred in the response from the server is likely to be duplicated blocks of code with different values in the fields. For example, the following HTML is repeated three times with different values:
<div>Bill</div>
<div>Bob</div>
<div>Joe</div>

The HTML for each element is a simple <div></div> tag group, and it is repeated with different first names inserted. However, because the HTML was rendered in the server-side code, the entire string of HTML code is sent to the client. In this small example, the amount of code is negligible. However, on large websites with extremely large numbers of repeating objects, this is very inefficient and requires much more bandwidth than should be necessary.

Client-side templates send a copy of the template to the client's browser, along with structured data to serve as a data source, and the template is populated with JavaScript in the browser. This method greatly reduces bandwidth usage between the client and server on sites that have a large amount of content with duplicated formatting.

Client-side templates are typically managed by templating engines that are written in JavaScript. Therefore, they run within the JavaScript virtual machine built into the web browser. In this scenario, only one copy of the template is sent in the response from the web server, along with a string of structured data to be used for populating the template. The templating engine in the web browser is then called in JavaScript code within the document to parse the data source, replace the tags appropriately within the template, and then render the template as many times as needed within the browser.

FIG. 4 illustrates a typical coding structure for producing a client-side template using the same example as shown above, but implemented in client-side templating. While this example comprises more lines of code than the server-side example, it does not grow in size as the number of elements in the data source grows. In other words, if the “names” variable contained 100 names, the only change would be that one line would be longer, and no other lines of code are needed. Additionally, if the data source was referencing a function (as shown in the commented code line), the amount of data items could be extremely large without additional code being written.

Most importantly, however, is the fact that this is the total amount of code that would be required to be sent in the web server response, and the data string could be sent in separate calls to the server as needed.

Thus, using client-side templates provides a large decrease in bandwidth required for a large website containing several blocks of repeated markup sections. Additionally, since the HTML template is already loaded into the browser, additional calls to the server for more data can be made asynchronously to populate a site with fresh content, or additional content, in response to time passing or user interaction of the page.

Client-side templating engines are typically written in JavaScript and are available with open source as well as commercial licensing. While they produce the advantages stated above, none are as robust as their server-side counterparts with regard to nesting, embedded logic, and the capability to pass complex data structures.

FIG. 5 illustrates a simplified example of the use of client-side templates in a conventional website. This example uses Handlebars.js, which is a popular templating engine. Those skilled in the art will readily recognize this coding structure. Although such a templating system assists with modularity, as well as separating presentation design from the data source, on a very large site with a large number of modular sections, collisions in class definitions and the increased polling required to attach listeners to specific DOM elements negatively impact scaling, performance, and reliability.

FIG. 6 illustrates a typical coding structure for the use of a common client-side templating engine, which allows a reusable template to be populated from a data source. In this example, an HTML template containing replaceable tags for “title” and “body” is included in a script block. The templating engine then compiles the template. Then, a data source is defined, which may be static data or a web service that returns the data in a usable format. The example includes hard-coded static data for demonstration purposes only. Those tags in the compiled template are replaced by data contained in the data source object, based on the names for each of the object elements. For example, {{title}} in the template may be replaced by “My New Post”, when that is the value of the “title” element in the data source object. HTML is rendered from the compiled template with replaced values and then the “div” element with the ID attribute of “content_div” is populated with the resulting HTML.

This method of programming allows for reuse of presentation mark up code (HTML), and separates the data from the presentation for maintainability and readability of the code. However, when scaled to larger sites, performance degrades quickly because the compilation of templates and the bloat in the third-party templating engine library is expensive in terms of processing resources. Additionally, the excess polling problem mentioned previously is not addressed. Once the template is compiled, values are replaced, and HTML is generated, the JavaScript must search the DOM for the correct element to populate with the results. Again, this causes increasingly poor performance as the size of the site grows and the number of DOM elements increases. The possibility of class collisions also still exists.

When building an interactive web application, client-side code written in JavaScript is typically used to attach event listeners onto DOM elements, run specific callback functions when those events are triggered, and manipulate the DOM elements as necessary to provide feedback for user interaction. In all but the smallest and simplest applications, it is often necessary to include more than one script tag in the DOM, which includes the JavaScript code to manage the application. This is especially the case when creating modular applications in which each module contains a script block to control the module to which the script block is attached.

FIG. 7A illustrates a typical coding structure for managing DOM elements defined just prior to a script block. The code contains two sections of code, which includes HTML markup and two JavaScript blocks. In this example, the code in the two script blocks will run sequentially as the browser loads them into the DOM. This method of development is typical and does not pose problems in simple web applications with very little user interaction required. However, as web applications have become more complex, a need to reference which script block's code is currently running has developed. One example of this is when scripts are being loaded dynamically in repeated modules on a single page, and each script block is required to act on DOM elements only within the module to which the script block is attached.

FIG. 7B illustrates a typical coding structure for loading scripts dynamically in repeated modules on a single page. In this example, the first module will load into the DOM and the code in the module's script block will run, inserting the word “Contents” into the first <div> element with the class name of “container”, as expected. However, when the page continues loading, the second module will load into the DOM and the code in the second script tag will run. It will insert the word “Contents2” into all elements in the DOM that have the class of “container.” This will not only insert the content into the div tag contained as part of the second module, it will also replace the contents in the div tag which is part of the first module, because it also has the class name of “container.” Additionally, running the third module's code will result in the content of all three div elements being “Content3.”

The problem shown in this example can be avoided by having a unique ID for each div tag and writing the JavaScript to reference the tag by the ID attribute. However, this limits code reuse and many other advantages gained by using a modular, template-driven website composition.

FIG. 8 illustrates a coding structure for an alternative way to load scripts dynamically in repeated modules on a single page. In this example, the problem is solved by making the scripts aware of themselves, and referencing only the DOM elements relative to each script. However, although this method solves the problem when loading modules sequentially, it does not work when modules are loaded dynamically or asynchronously. Also, the currentScript property is likely to return a reference to the incorrect DOM element should another script be running asynchronously elsewhere in the page. The currentScript property is also not supported in many older browsers.

### SUMMARY

The typical method of developing a website does not lend itself to modularity, and performance is greatly reduced as the site scales in size and traffic. The trend is for websites to use a variety of disparate data sources to build content in a modular fashion, and then to compile the modules together to form a webpage. As the number of different types of modules increases, or even the number of modules of a single type increases, class collisions and excess DOM polling create instability and performance degradation in the browser, as well as an increased load on the server. Additionally, because the modules are loaded synchronously as the page is rendered, the poor performance of a single module negatively affects all other modules below it in the DOM structure.

It would be advantageous to have a method of assembling the contents of a website that overcomes the deficiencies of traditional website design methodologies. The disclosed solution provides the bandwidth savings and performance enhancements of the typical client-side solution, with the robust feature set that server-side engines typically employ. This is achieved, in part, by encapsulating each module, and programming the software to sandbox the CSS and JavaScript for each module to avoid collisions, while at the same time, allowing modules to interact on a specified level as needed during user interaction.

According to the embodiments of the present disclosure, a method of software development is provided which creates a modular website, in which each module contains an HTML template, as well as a JavaScript block referred to as a “Driver”, which, when initialized, provides the data source and any DOM manipulation instructions necessary to make the template elements behave as desired. The combination of these elements creates a website that is modular and capable of using disparate data sources while eliminating the performance degradation and class collisions associated with other methods.

One embodiment is directed toward the development of a client-side templating engine, which uses simple string replacement to populate elements from a data source. The templating engine does not require compilation, and does not contain code for logical operators or other unnecessary functionality found in other commercial and open source offerings. The engine performs all of the functionality required to return HTML from a call to a single function. Calling this function from JavaScript code, and sending the correct information in the call, allows the templating engine to retrieve the proper template as well as retrieve and parse the data source. The templating engine retrieves all required information from a server-side controller when called correctly, thus eliminating the need to specify a data source for the module. Additionally, the module templates may be compressed and cached in the client's browser as JavaScript Object Notation (JSON) files so that repeated calls for the same template does not require a request being sent to the web server. This greatly improves bandwidth utilization, performance, and scalability of the web application.

Another embodiment is directed toward the use of class namespacing in the CSS portions of each module. This embodiment eliminates class collisions and speeds up DOM polling when attaching listeners to DOM elements, or when manipulating DOM elements.

Another embodiment is directed toward a “Driver” for each module, written in JavaScript. The Driver receives instructions from the calling script and performs a number of functions. The Driver retrieves data from a defined data source for the module, populates and renders the template portion of the module, attaches listeners to the DOM elements of the template, and manipulates the DOM elements of the template as needed in order to allow user interaction with the module.

Another embodiment is directed toward a method of initializing and running the Driver code for each module asynchronously, rather than having one module waiting for another. This functionality improves the user experience and ensures the performance of each module does not affect the performance of other modules.

Another embodiment is directed toward a method of programming that allows “nesting” of modules. In this embodiment, a first module may call for a second module, which when parsed, becomes one or more smaller, repeatable parts of the first module. This allows for modules themselves to be modular, and allows for better maintainability, faster development, and more efficient processing of the Drivers controlling the modules.

Another embodiment is directed toward a method of loading separate DOM modules utilizing self-referencing of running script elements. The method allows the loading of modules either sequentially or dynamically in any order, even when another script is running asynchronously elsewhere on the page. The method also allows nested modules to be loaded to create parent-child relationships between modules, while maintaining the correct context for the running code within each individual module.

Further features and benefits of embodiments of the disclosure will become apparent from the detailed description below.

### BRIEF DESCRIPTION OF THE DRAWINGS

In the following section, the invention will be described with reference to exemplary embodiments illustrated in the figures, in which:

FIG. 1 (Prior Art) illustrates a typical conventional coding structure for a simple website;

FIG. 2 (Prior Art) is a message flow diagram illustrating the flow of messages between a user, a client browser, and a website server in a method of operating a conventional static website;

FIG. 3A (Prior Art) illustrates a typical coding structure for producing a simple server-side template;

FIG. 3B (Prior Art) illustrates a typical coding structure for replacing the tags in the server-side template of FIG. 3A with data;

FIG. 4 (Prior Art) illustrates a typical coding structure for producing a client-side template;

FIG. 5 (Prior Art) illustrates a typical conventional coding structure for the use of client-side templates in a conventional website;

FIG. 6 (Prior Art) illustrates a typical conventional coding structure for the use of a client-side templating engine;

FIG. 7A (Prior Art) illustrates a typical coding structure for managing DOM elements defined just prior to a script block;

FIG. 7B (Prior Art) illustrates a typical coding structure for loading scripts dynamically in repeated modules on a single page;

FIG. 8 (Prior Art) illustrates a coding structure for an alternative way to load scripts dynamically in repeated modules on a single page;

FIG. 9 illustrates the skeleton code for beginning to program a module in accordance with the present disclosure;

FIG. 10 illustrates the coding structure for use of a template driver system to create a modular section of a larger HTML document;

FIG. 11 illustrates the coding structure for the “post” module called in lines 14 and 17 of the code in FIG. 10;

FIG. 12 illustrates the coding structure for the “ad” module called in line 20 of the code in FIG. 10;

FIG. 13 illustrates the coding structure for an example of nesting modules;

FIG. 14 illustrates the coding structure for the example “album” module of FIG. 13;

FIG. 15 illustrates the coding structure for a procedure for calling the code to create a “photo” module;

FIG. 16A illustrates objects representing a simple data structure in a single level;

FIG. 16B illustrates objects representing a slightly more complex data structure having two levels;

FIG. 16C illustrates objects representing a complex data structure supported by the Driver system of the present disclosure;

FIG. 17 is a simplified block diagram of the client-side web browser of the present disclosure;

FIG. 18 is a simplified block diagram of the client-side web browser of the present disclosure; and

FIG. 19 is a flow chart illustrating an exemplary embodiment of a method according to the present disclosure.

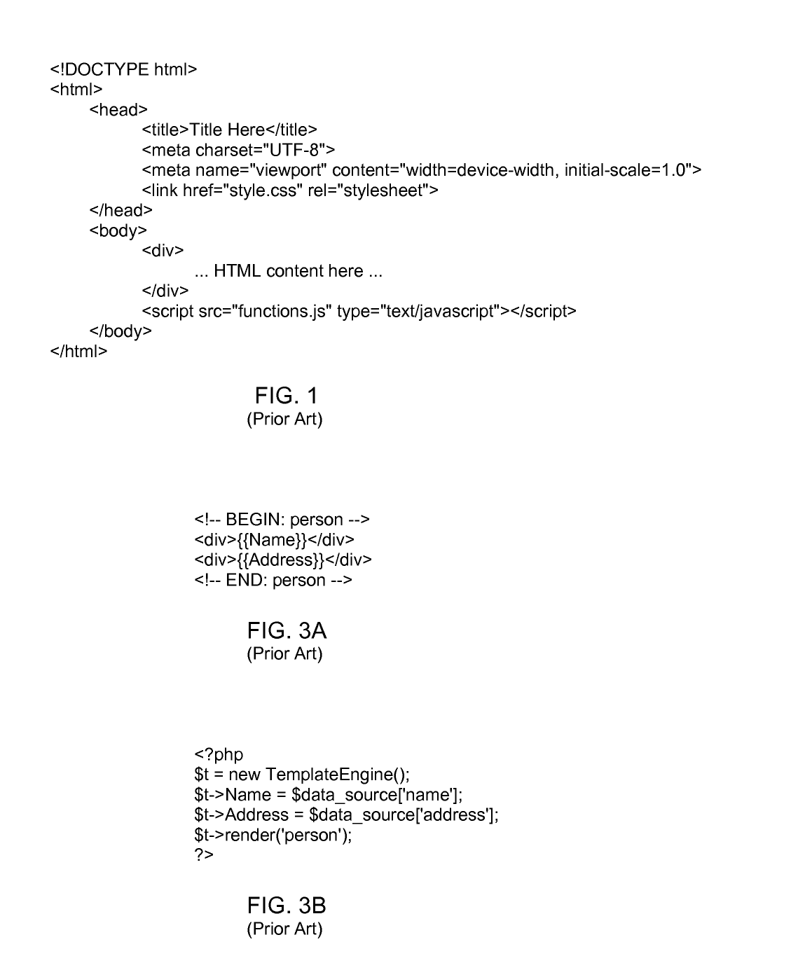

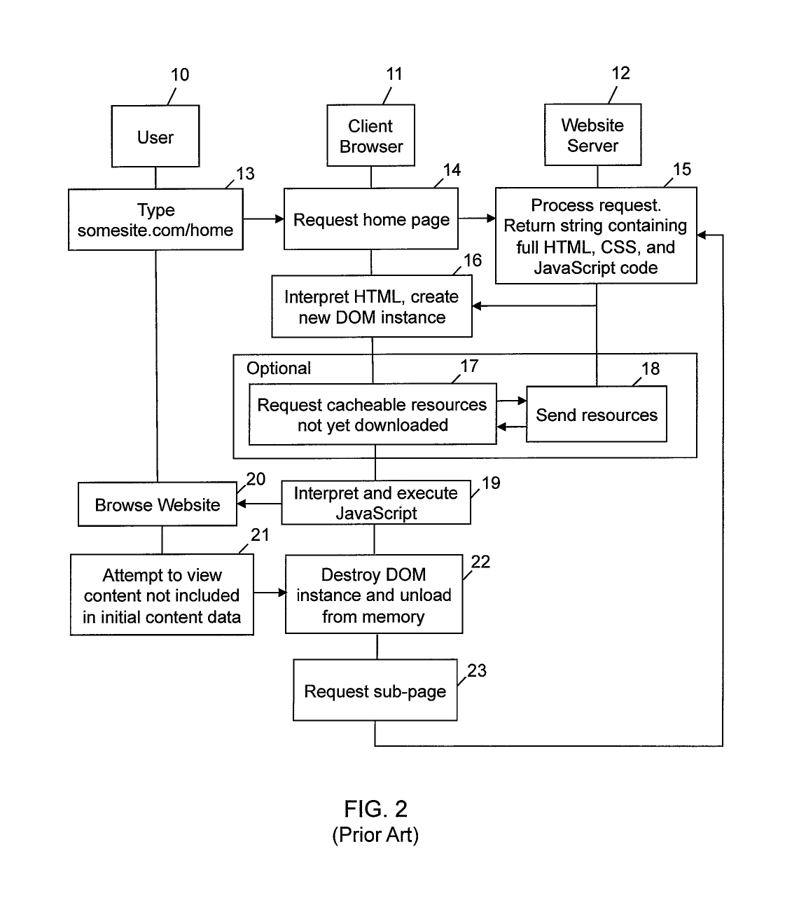

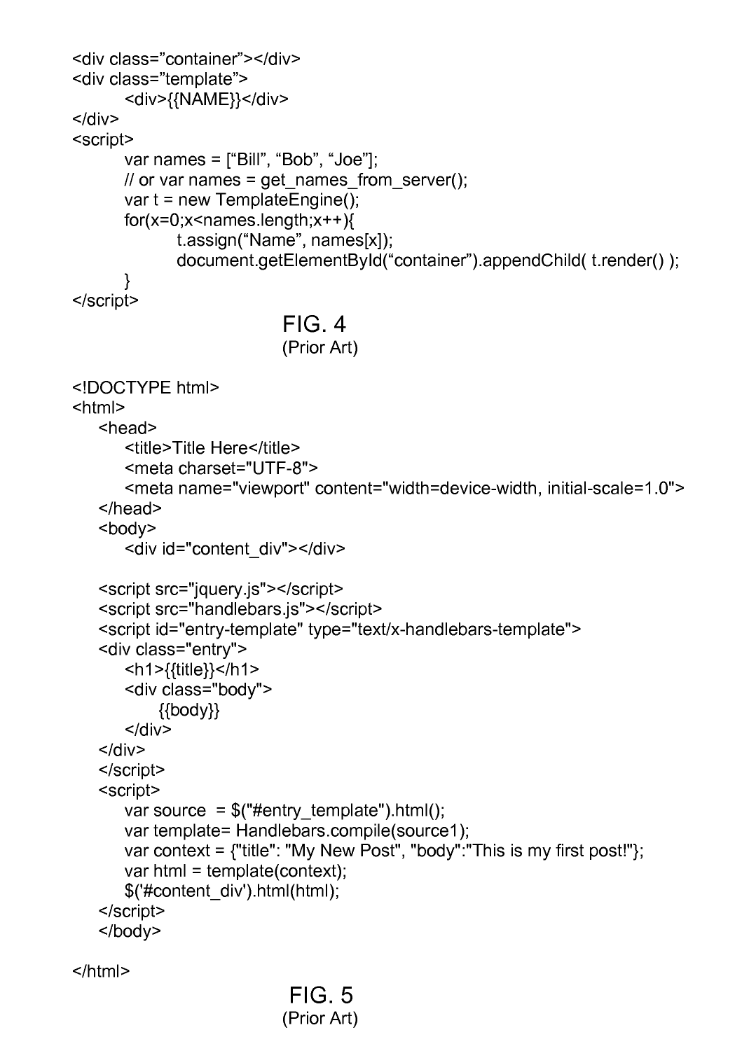

### DETAILED DESCRIPTION

The present disclosure will now be described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements. Additionally, it should be understood that the invention can be implemented in hardware or a combination of software stored on a non-transitory memory and executed by a general purpose computer or microprocessor. Various “servers” and “systems” disclosed herein are understood by those skilled in the art to include processors, non-transitory memories, and software comprising computer program instructions to be executed by the processors thereby causing the servers and systems to perform the stated functions.

FIG. 9 illustrates the skeleton code for beginning to program a module in one exemplary embodiment of the present disclosure. This embodiment illustrates that the module includes a module Driver written in JavaScript. The Driver code for each module may be initialized and run asynchronously, rather than having one module waiting for another. This functionality improves the user experience and ensures the performance of each module does not affect the performance of other modules. Once initialized, the Driver receives instructions from the calling script and may retrieve data from a defined data source for the module, populate and render the template portion of the module, attach listeners (triggers) to the DOM elements of the template, and manipulate the DOM elements of the template as needed in order to enable user interaction with the module.

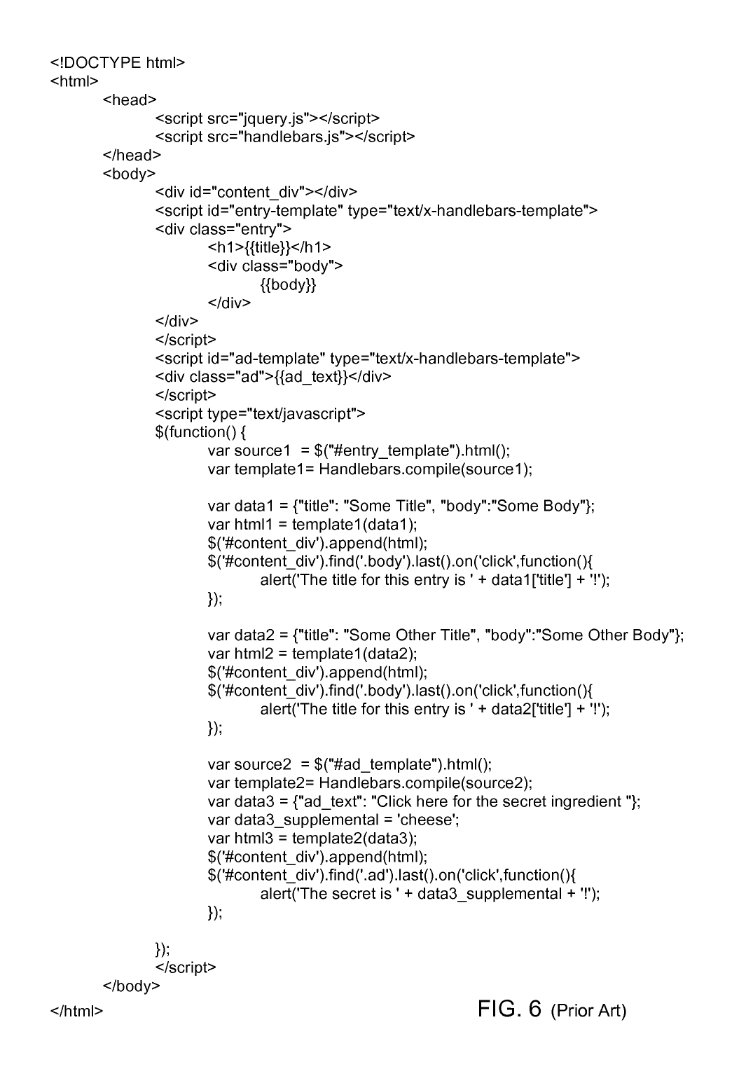

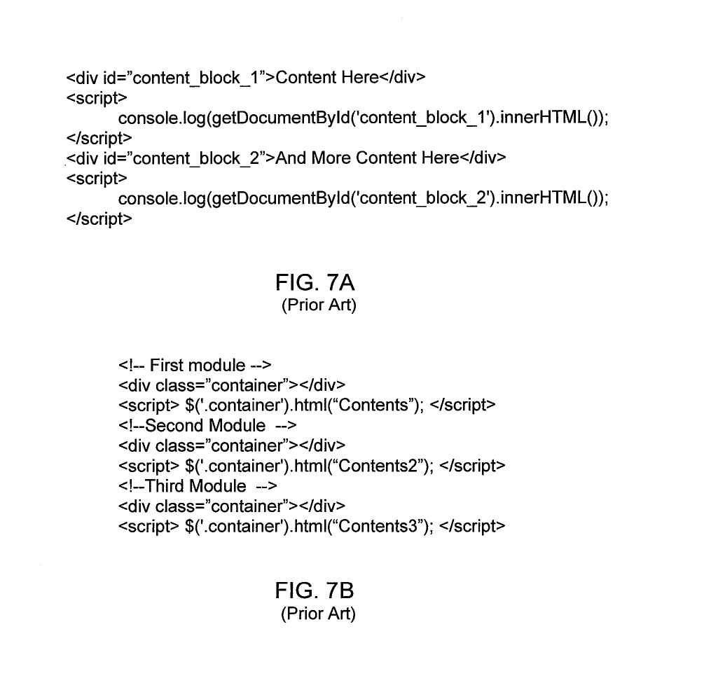

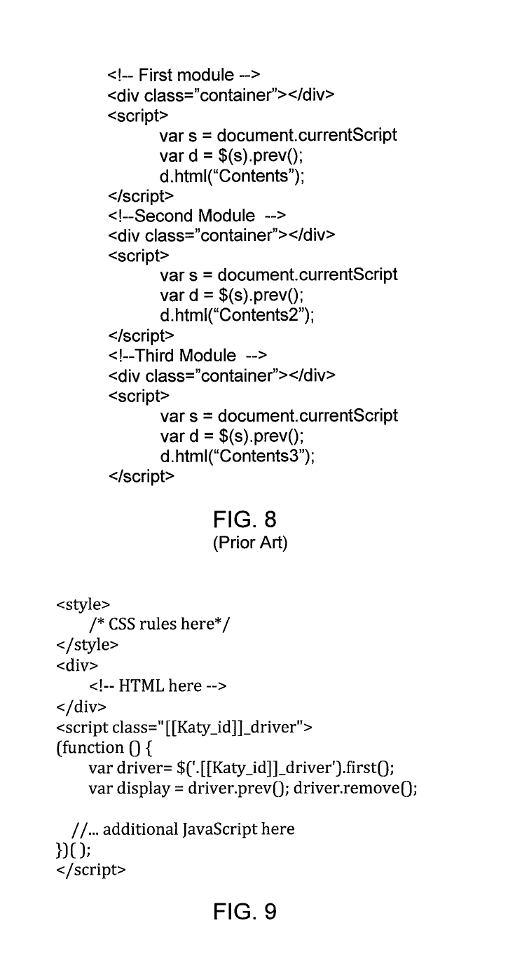

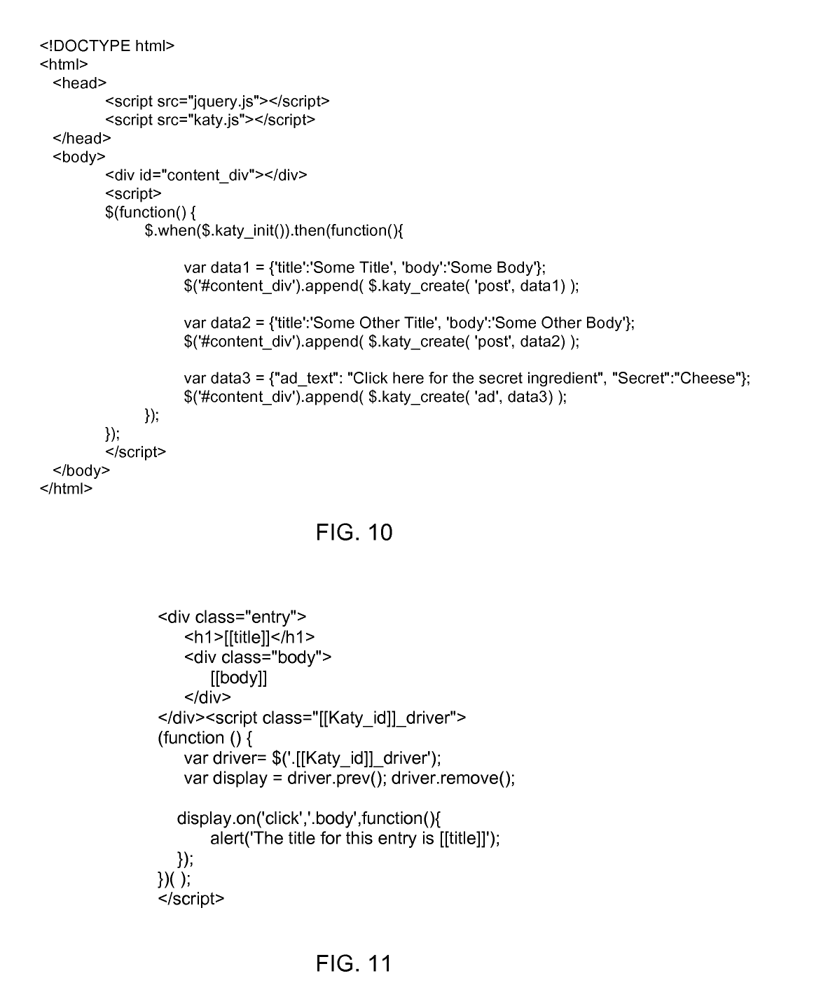

FIG. 10 illustrates the coding structure for use of a template driver system to create a modular section of a larger HTML document. This process produces templates similar to the method of FIG. 6, but utilizes a modular architecture and employs a JavaScript Driver for each module. In this example, the <div> tag with the ID of “content_div” becomes a container for the content that will be generated. With the templating engine given the nickname “Katy Library”, functions beginning with “katy_” are calling methods within that templating engine library. The first function in line 11 of the code, katy_init( ) reports back when the engine is ready to begin processing templates and data. Then, within that conditional block, three modules are called using the katy_create( ) function. The katy_create( )function takes two arguments: the type of module to create (such as “post” or “ad”) and the data to pass to the module (such as “data1”, “data2”, or “data3”). This information is hard coded in the example, but it may also be from a remote data source, which returns the required data in a JSON format.

FIG. 11 illustrates the coding structure for the “post” module called in lines 14 and 17 of the code in FIG. 10. The top five lines of the module provide the HTML template portion, which contains tags to be replaced with data. In this example, there are two tags—[[title]] and [[body]]. The templating engine utilizes string replacement to replace these tags with the values passed to it in the data source variable—the second argument passed to the katy_create( ) function as noted above. Below the HTML markup code, or template, is a JavaScript block containing the Driver for this individual module. It also has a tag, [[Katy_id]], in line 6 of the code, which is populated with the internal ID of the module, thereby creating a unique class attribute for this block of JavaScript, or Driver. This enables the Driver to run independently from other Drivers being loaded in an asynchronous manner. Also, by setting the “display” variable in the JavaScript to reference the DOM element in the template portion just prior to the Driver (i.e., ‘body’), all action by the JavaScript can be sandboxed (i.e. isolated) into that DOM element, in effect, and collisions are prevented. This also eliminates unnecessary polling for matching DOM elements by the JavaScript and greatly improves performance.

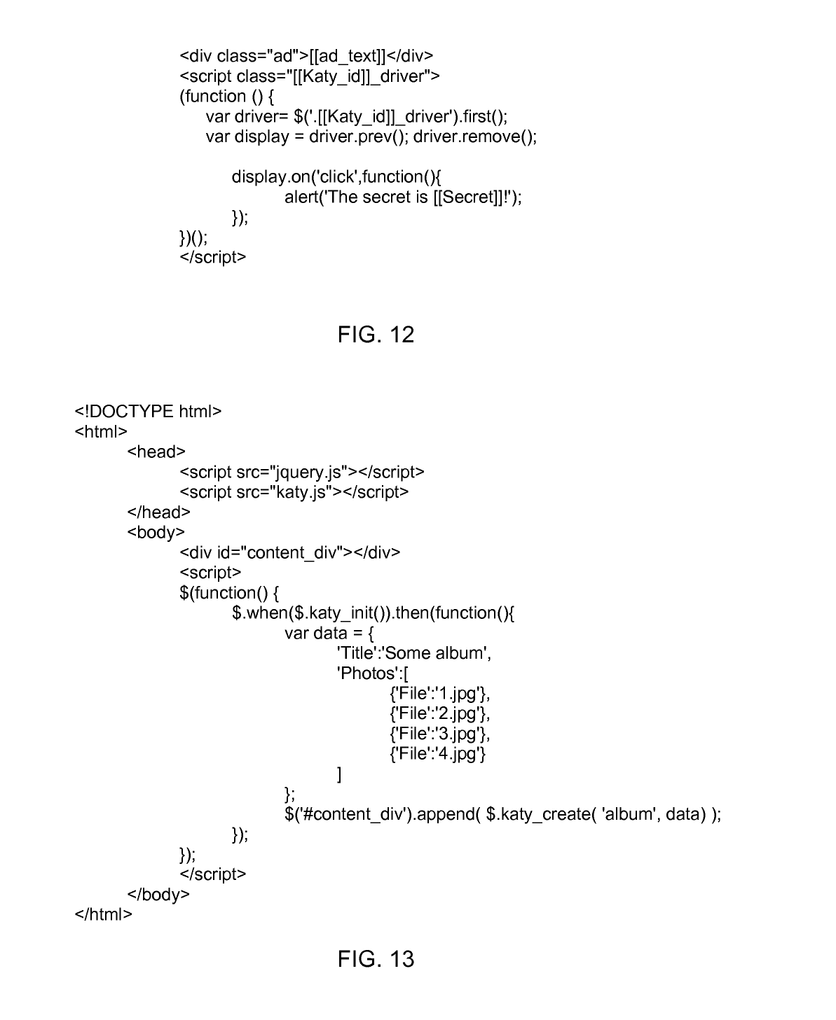

FIG. 12 illustrates the coding structure for the “ad” module called in line 20 of the code in FIG. 10. As described above, the tag [[ad_text]] is replaced by the value of data referencing the same name. Also, the [[Katy_id]] tag is populated with the internal ID of the module once again, so that the Driver in this module can run its code asynchronously without affecting or waiting on the Drivers of other modules. Again, all actions by the Driver code can be sandboxed by referencing the elements within the DOM node, as set in the “display” variable.

FIG. 13 illustrates the coding structure for an example of nesting modules. The nesting feature enables modules to be made from a collection of other, smaller modules. In this way, code may be broken into smaller and more manageable pieces to improve maintenance and development quality. An example is a photo “album” module, which comprises several “photo” modules. In the illustrated example, the data source contains an album object, and an array of photo objects. A single call is made to the Katy Library to create the album module using the katy_create( ) method. In line 21 of the code shown in FIG. 13, the katy_create( ) method is invoked, and a JavaScript object is passed in the second parameter comprising the data needed to build the album. There is an album title, and a collection of photos to be included in the album. Katy then retrieves the album template and replaces the title tag in the album module template with the album title in the data source. Then, the JavaScript module Driver within the template iterates through the photo elements, calling the katy_create( ) method for each one and creating a photo module. As the photo modules are created, they are appended to the template of the album module, and when complete, the entire block of HTML is returned to represent the full album of photos.

In this manner, the complex data object that was originally passed to the Katy Library to create the album is cascaded down as needed to build as many nested layers as necessary. The nesting levels are unlimited by the library and multiple level complex data objects can be cascaded down through any number of layers to build very complex, but modular website content.

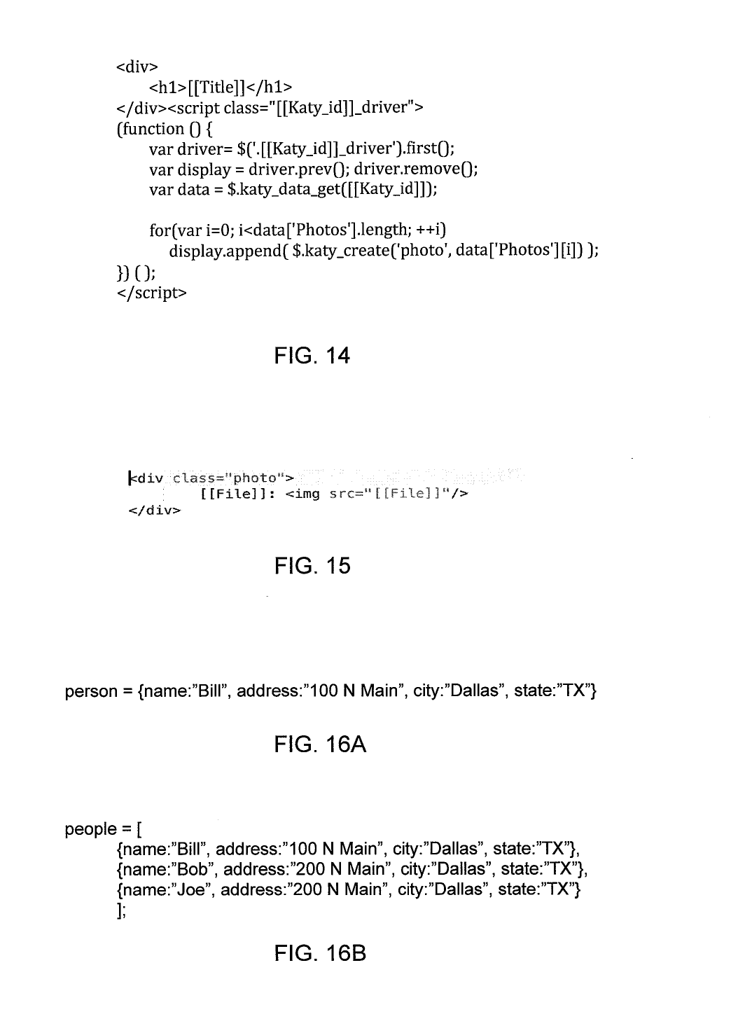

FIG. 14 illustrates the coding structure for the example “album” module of FIG. 13. In this example, the [[Title]] tag is replaced with the album title value passed in the data source variable. The “Photos” array is then iterated and the value of each array element is passed to the katy_create( ) method, which returns a photo module and appends that module into the album module. Once the iteration is complete, the entire album module is returned to the original katy_create( ) method shown in FIG. 9.

FIG. 15 illustrates the coding structure for a procedure for calling the code to create a “photo” module. This module is very simple, and contains only an HTML template, as no user interaction is required. The [[File]] tag is replaced by the value passed in the data object sent to the katy_create( ) method in FIG. 14, and the HTML is returned to that function. If user interaction or DOM manipulation is needed in this module, a JavaScript Driver is appended after the containing <div> element as shown in the other module examples described above.

Looking in further detail at the client-side templating engine of the present disclosure, the following features become evident (with the engine given the nickname “Katy Library” all methods are prefixed with “katy_”):

The ability to pass complex data structures. Data streams are typically passed as JavaScript object instances or JavaScript array instances, but are usually limited to a single level and with all elements of the object having string values.

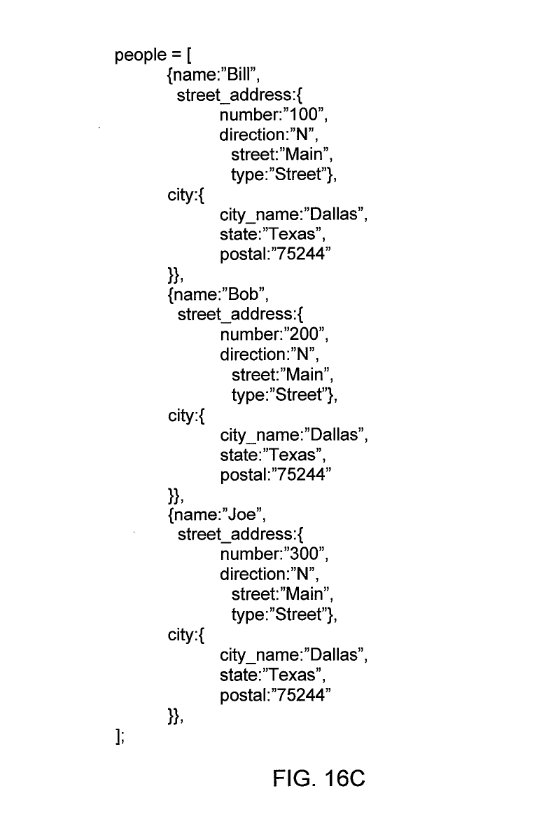

FIG. 16A illustrates objects representing a simple data structure in a single level.

FIG. 16B illustrates objects representing a slightly more complex data structure having two levels.

FIG. 16C illustrates objects representing a complex data structure supported by the Driver system of the present disclosure. Such complex data structures can develop very quickly when building modular website components with nesting capabilities.

Supporting this type of complex data structures enables other robust features of the Katy Library, specifically nesting (as described above) and embedded logic and other client-side code. Embedded logic and other client-side code provide additional capabilities. For example, the template may include a mixture of HTML and JavaScript code, and the data source can be used to populate fields in any portion of that template. The JavaScript can then run complex logical calculations on the data and display different portions of the template, or display portions of the template differently, depending on the results of those calculations. Additionally, JavaScript code can be used similarly to manage the DOM elements of the HTML template in order to attach event listeners to those objects, or manipulate the objects based on user interaction or other events. Such code may be implemented in module Drivers, which often accompany the template code.

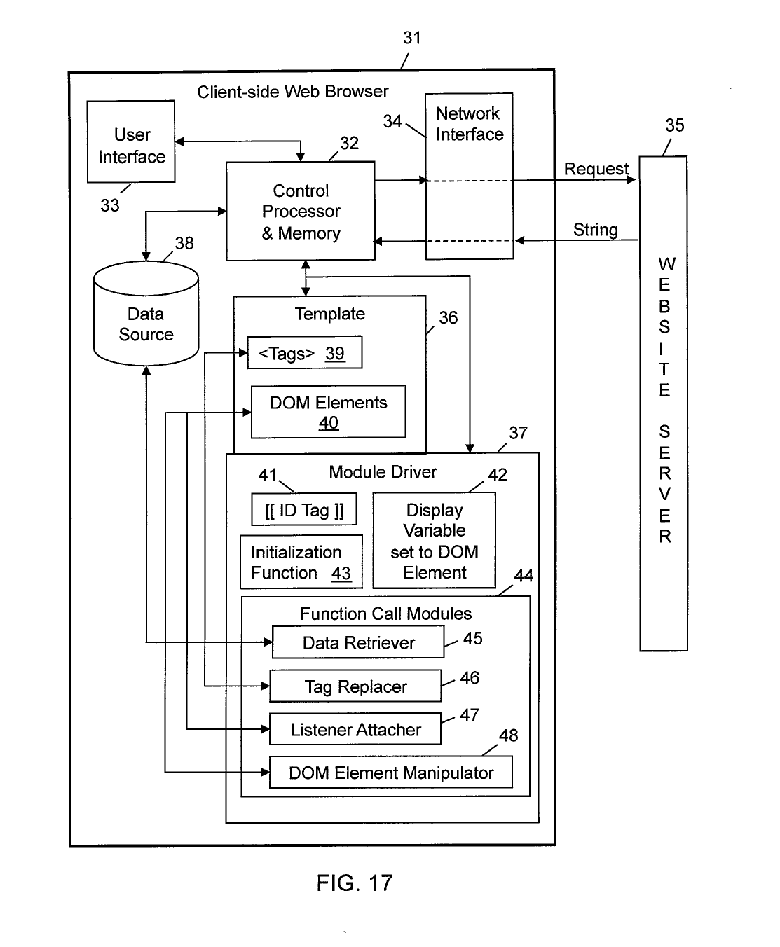

FIG. 17 is a simplified block diagram of the client-side web browser 31 of the present disclosure. Operation of the browser may be controlled, for example, by a control processor 32 and associated memory for storing computer program instructions. A user interface 33 enables communication to and from the user, and a network interface 34 enables communication to and from a website server 35. The browser may request information for a website from the server by sending, for example, an HTTP request to the server. In response, the browser receives an information string containing resources such as a minimal amount of HTML, CSS, and JavaScript code, and compressed initial content data associated with DOM modules for the website home page encoded in a cacheable JSON file. For a given module, the information received from the server includes HTML code for a template 36 and JavaScript code for a module Driver 37. The content may be stored in cache or in a data source 38.

The template 36 may include various tags 39 such as the <div> tag with the ID of “content_div”, which becomes a container for the content that will be generated. The template may also include various DOM elements 40 that provide the functionality of the module, once populated by the Driver 37. The Driver may include an ID tag 41, a Display variable 42, which is set to a DOM element 40 in the template, an initialization function 43 and call function modules 44. The call function modules may include a data retriever module 45, a tag replacer 46, a listener attacher 47, and a DOM element manipulator 48.

Once initialized, the Driver 37 receives instructions from the calling script and may retrieve data from a defined data source for the module, populate and render the template portion of the module, attach event listeners (triggers) to the DOM elements of the template, and manipulate the DOM elements of the template as needed in order to enable user interaction with the module.

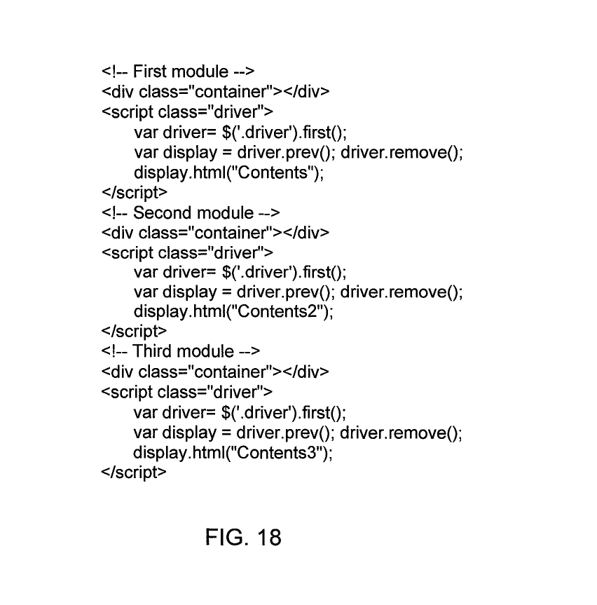

FIG. 18 illustrates the coding structure for a method of loading separate DOM modules utilizing self-referencing of running script elements. The method allows the loading of modules either sequentially or dynamically in any order, even when another script is running asynchronously elsewhere on the page. The method also allows nested modules to be loaded to create parent-child relationships between modules, while maintaining the correct context for the running code within each individual module. In this example, when the script runs, the JavaScript code creates a reference to itself and places the reference into the variable “driver”. Then, the display variable is set to a DOM element that can be found relative to the Driver, which allows the JavaScript to understand the context within which to manipulate the DOM.

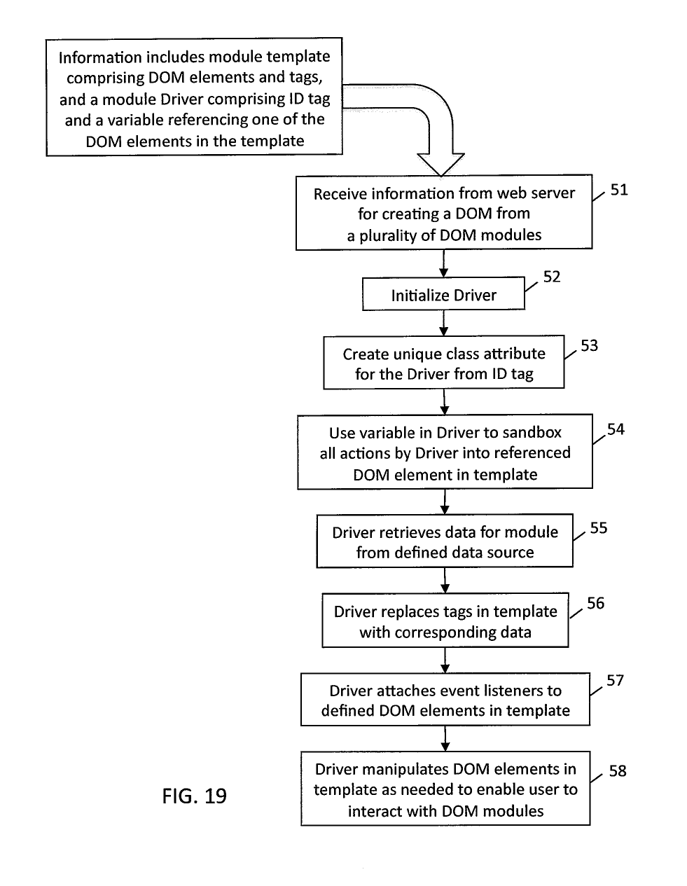

FIG. 19 is a flow chart illustrating an exemplary embodiment of a method according to the present disclosure. The method, performed in the client web browser, prevents collisions between DOM modules and eliminates polling for matching DOM elements while operating a website. The web browser is implemented in a computer and is in communication with a website server via a network connecting the computer and the web server. At step 51, the browser receives from the web server, information for creating a DOM from a plurality of DOM modules for displaying content to a user and interacting with the user. The received information includes a module template comprising DOM elements and tags to be replaced with data, and a module Driver comprising an identifier tag and a variable, which is set to reference one of the DOM elements in the template. At step 52, the Driver is initialized. At step 53, the browser creates from the Driver's identifier tag, a unique class attribute for the Driver, thereby enabling the Driver to operate independent of other DOM modules. At step 54, the variable in the Driver is utilized to sandbox all actions by the Driver into the referenced DOM element in the template, thereby preventing collisions and eliminating polling for matching DOM elements. At step 55, the Driver retrieves data for the module from a defined data source. At step 56, the Driver replaces the tags in the template with corresponding data. At step 57, the Driver attaches event listeners to defined DOM elements in the template, and at step 58, the Driver manipulates DOM elements in the template as needed to enable user interaction with the DOM module.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A client web browser configured to prevent collisions and eliminate polling for matching Document Object Model (DOM) elements while operating a website, wherein the web browser is in communication with a website server via a network connecting the web browser and the web server, the web browser comprising:
a network interface that receives from the web server, information for creating a DOM from a plurality of DOM modules that display content to a user and interact with the user, wherein each DOM module is stored in cache or permanent memory and is executed by a processor controlling the client-side web browser, wherein at least one of the plurality of DOM modules includes:
a module template comprising DOM elements, and tags to be replaced with data; and
a module Driver comprising:
an identifier tag that creates a unique class attribute for the Driver, thereby enabling the Driver to operate independent of other DOM modules; and
an initialization function that causes the Driver to create function call modules defined in the received information, the function call modules including:
a first function call module that retrieves data for the module from a defined data source; and
a second function call module that replaces the tags in the template with corresponding data.

2. The client web browser as recited in claim 1, wherein the Driver also includes a variable, which is set to reference a DOM element in the template, thereby sandboxing all actions by the Driver into the referenced DOM element in the template, preventing collisions, and eliminating polling for matching DOM elements.

3. The client web browser as recited in claim 1, wherein the initialization function of the Driver also causes the Driver to create a third function call module that attaches event listeners to defined DOM elements in the template.

4. The client web browser as recited in claim 3, wherein the initialization function of the Driver also causes the Driver to create a fourth function call module that manipulates DOM elements in the template as needed to enable user interaction with the DOM module.

5. A Document Object Model (DOM) module Driver implemented in a DOM module, wherein the DOM module is one of a plurality of DOM modules constituting a website DOM, wherein the DOM module includes the DOM module Driver and a module template comprising DOM elements and tags to be replaced with data, wherein the DOM module is stored in cache or permanent memory and is executed by a processor controlling a client-side web browser to display content to a user and interact with the user while operating a website, the DOM module Driver comprising:
an identifier tag that creates a unique class attribute for the Driver, thereby enabling the Driver to operate independent of other DOM modules; and
an initialization function that initializes the Driver and causes the Driver to create function call modules, the function call modules including:
a first function call module that retrieves data for the module from a defined data source; and
a second function call module that replaces the tags in the template with corresponding data.

6. The DOM module Driver as recited in claim 5, further comprising a variable, which is set to reference a DOM element in the template, thereby sandboxing all actions by the Driver into the referenced DOM element in the template, preventing collisions, and eliminating polling for matching DOM elements.

7. The DOM module Driver as recited in claim 5, wherein the initialization function of the Driver also causes the Driver to create a third function call module that attaches event listeners to defined DOM elements in the template.

8. The DOM module Driver as recited in claim 7, wherein the initialization function of the Driver also causes the Driver to create a fourth function call module that manipulates DOM elements in the template as needed to enable user interaction with the DOM module.

9. A method in a client web browser for preventing collisions and eliminating polling for matching Document Object Model (DOM) elements while operating a website, wherein the web browser is implemented in a computer and is in communication with a website server via a network connecting the computer and the web server, the method comprising:
receiving from the web server, information for creating a DOM from a plurality of DOM modules that display content to a user and interact with the user, wherein the information includes a module template comprising DOM elements and tags to be replaced with data, and a module Driver comprising an identifier tag and a variable, which is set to reference one of the DOM elements in the template;
creating from the identifier tag, a unique class attribute for the Driver, thereby enabling the Driver to operate independent of other DOM modules;
retrieving by the Driver, data for the module from a defined data source; and
replacing by the Driver, the tags in the template with corresponding data.

10. The method as recited in claim 9, further comprising utilizing the variable to sandbox all actions by the Driver into the referenced DOM element in the template, thereby preventing collisions and eliminating polling for matching DOM elements.

11. The method as recited in claim 9, further comprising attaching by the Driver, event listeners to defined DOM elements in the template.

12. The method as recited in claim 11, further comprising manipulating by the Driver, DOM elements in the template as needed to enable user interaction with the DOM module.
